(19) United States
(12) Patent Application Publication
(10) Pub. No.: US 2015/0382298 A1
(43) Pub. Date: Dec. 31, 2015

(54) METHOD AND NETWORK NODE FOR SETTING A MOBILE COMMUNICATION TERMINAL IN AN IDLE MODE

(71) Applicant: TELEFONAKTIEBOLAGET L M ERICSSON (PUBL), Stockholm (SE)

(72) Inventors: Walter Müller, Upplands Vasby (SE); Ingrid Nordstrand, Sundbyberg (SE); Mojgan Fadaki, Solna (SE); Stefan Johansson, Linkoping (SE); Lars-Bertil Olsson, Angered (SE); Göran Rune, Linkoping (SE)

(21) Appl. No.: 14/764,882

(22) PCT Filed: Feb. 15, 2013
(86) PCT No.: PCT/EP2013/053062

§ 371 Date: Jul. 30, 2015

(51) Int. Cl. H04W 52/02; H04W 72/04; H04L 5/00; H04W 24/02

(52) U.S. Cl. CPC H04W 52/0212; H04W 24/02; H04W 72/0406; H04L 5/0044; H04W 88/02

(57) ABSTRACT

A method for setting a mobile communication terminal of a cellular communication network in an idle mode. The method is performed in a network node and comprises the steps of starting a first inactivity timer; starting a second inactivity timer; resetting the first inactivity timer when control signalling associated with the mobile communication terminal is detected; resetting the second inactivity timer when payload data associated with the mobile communication terminal is detected; and setting the mobile communication terminal in an idle mode when both the first inactivity timer and the second inactivity timer have expired. A corresponding network node is also presented.

### TECHNICAL FIELD

The invention relates to a method and a network node for determining when to set a mobile communication terminal in an idle mode.

### BACKGROUND

In cellular communication networks, there are mobile communication terminals in communication with the network. Since the mobile communication terminals are allowed to be mobile, they typically contain their own power supply, such as a battery. Increasing battery life is thus an ever-present challenge for cellular communication systems. On the other hand, speed and responsiveness often require more power usage from the mobile communication terminals, whereby a balance between power usage and responsiveness is in many cases needed.

One way to balance the responsiveness and power usage in the mobile communication terminals is to remove radio access bearers for mobile communication terminals where the user is inactive, as mentioned in 3GPP technical specification 36.413 V11.2.0. In this way, battery power and network resources are saved when the mobile communication terminal is inactive.

However, in some situations, this leads to the mobile communication terminal going to an idle mode, even when communication downlink (to the mobile communication terminal) or uplink (from the mobile communication terminal) occurs soon after going into idle mode.

It would be greatly beneficial if there was a way to avoid at least some instances of setting the mobile communication terminal in idle mode when uplink or downlink communication occurs in the near future.

### SUMMARY

It is an object to provide a way for setting a mobile communication terminal in idle mode which reduces the risk of very soon afterwards having to set up communication again.

According to a first aspect, it is presented a method for setting a mobile communication terminal of a cellular communication network in an idle mode. The method is performed in a network node and comprises the steps of: starting a first inactivity timer; starting a second inactivity timer; resetting the first inactivity timer when control signalling associated with the mobile communication terminal is detected; resetting the second inactivity timer when payload data associated with the mobile communication terminal is detected; and setting the mobile communication terminal in an idle mode when both the first inactivity timer and the second inactivity timer have expired. By using a model where both inactivity timers have to expire for the mobile communication terminal to go be set to the idle mode, the risk of setting the mobile communication terminal in idle mode when control signalling still occurs is greatly reduced, increasing responsiveness and reducing resource requirements to set up a new connection. For example, this reduces paging load, risk of repeating SMS (Short Messaging Service) messages and failure during a positioning procedure, which may take a considerable amount of time.

The step of resetting the first inactivity timer may comprise resetting the first inactivity timer when control signalling between the mobile communication terminal and a second node distinct from the network node is detected. In other words, signalling not aimed for the network node can still be relevant and can cause the first inactivity timer to be reset.

In the step of setting the mobile communication terminal in an idle mode, the expiration times for the first inactivity timer and the second inactivity timer may differ. This gives full flexibility in terms of how long inactivity is accepted for control signalling and payload data, respectively.

In one embodiment, the content of the control signalling between the mobile communication terminal and the second node is not intended for the network node. Still, it is beneficial to allow such control signalling to trigger a reset of the first inactivity timer.

The step of setting the mobile communication terminal in an idle mode may comprise setting the mobile communication terminal in an RRC_IDLE mode.

The control signalling may comprise non-access stratum signalling.

The method may further comprise the step of: signalling values of the first inactivity timer and the second activity timer to a target node when handover to the target node occurs. In this way, the present state of the inactivity timers follows the mobile communication terminal to the target node when handover occurs, giving a more accurate state of the timers after a handover.

According to a second aspect, it is presented a network node arranged to set a mobile communication terminal of a cellular communication network in an idle mode. The network node comprises: a processor; and a computer program product storing instructions that, when executed by the processor, causes the network node to: start a first inactivity timer; start a second inactivity timer; reset the first inactivity timer when control signalling associated with the mobile communication terminal is detected; reset the second inactivity timer when payload data associated with the mobile communication terminal is detected; and set the mobile communication terminal in an idle mode when both the first inactivity timer and the second inactivity timer have expired.

The instructions to reset the first inactivity timer may comprise instructions to reset the first inactivity timer when control signalling between the mobile communication terminal and a second node distinct from the network node is detected.

The expiration times for the first inactivity timer and the second inactivity timer may differ.

The instructions to set the mobile communication terminal in an idle mode may comprise instructions to transmit a context release message.

In one embodiment, the content of the control signalling between the mobile communication terminal and the second node is not intended for the network node.

The control signalling may comprise non-access stratum signalling.

The instructions may further comprise instructions to: signal timer values of the first inactivity timer and the second activity timer to a target node when handover to the target node occurs.

The network node may be a radio base station.

The network node may be a mobility management entity node.

It is to be noted that any feature of the first aspect may, where appropriate, be applied to the second aspect and vice versa.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a cellular communication network where embodiments presented herein can be applied;

FIG. 2 is a state diagram illustrating various modes and transitions of the mobile communication terminal of FIG. 1;

FIGS. 3A-B are flow charts illustrating methods executed in a network node of FIG. 1 for setting a mobile communication terminal of a cellular communication network in an idle mode;

FIG. 4 is a schematic diagram illustrating elements of any one of the radio base stations of FIG. 1, here represented by a single radio base station; and

FIG. 5 is a schematic diagram illustrating elements of any one of the MME of FIG. 1.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

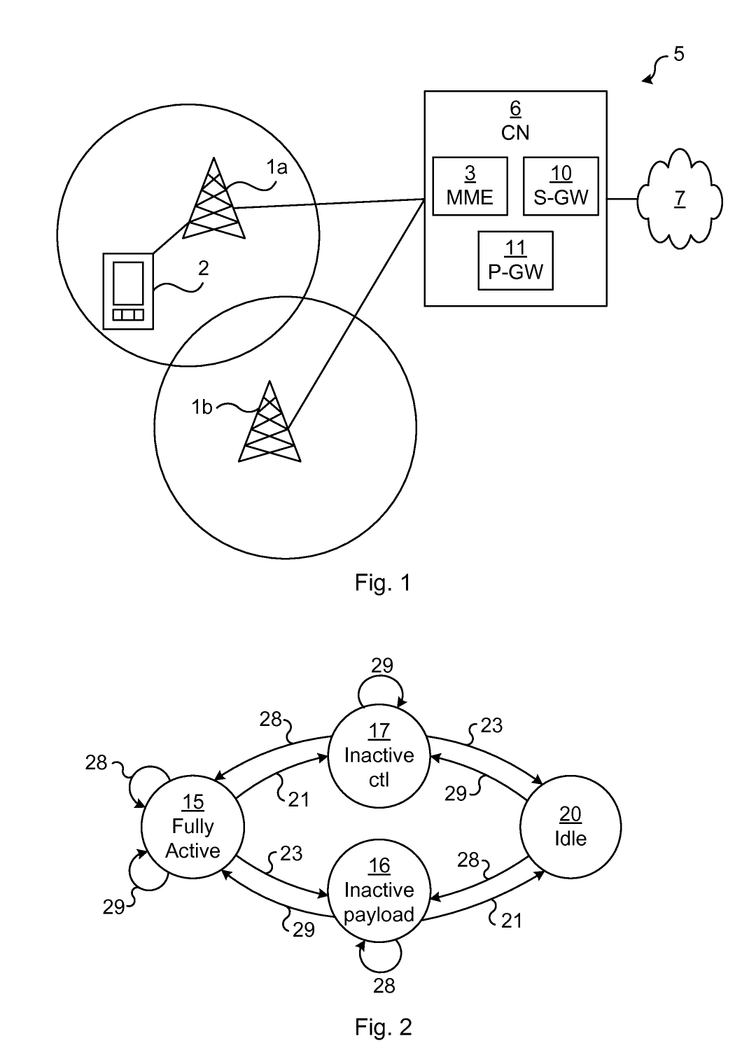

FIG. 1 is a schematic diagram illustrating a cellular communication network 5 where embodiments presented herein can be applied.

The cellular communication network 5 can e.g. comply with any one or a combination of LTE (Long Term Evolution), W-CDMA (Wideband Code Division Multiplex), EDGE (Enhanced Data Rates for GSM Evolution, GPRS (General Packet Radio Service)), CDMA2000 (Code Division Multiple Access 2000), etc., or any future cellular communication network standard, as long as the principles described hereinafter are applicable.

The mobile communications system 5 comprises a core network 6 and one or more network nodes in the form of radio base stations 1a-b, such as evolved Node Bs 1, also known as eNode Bs or eNBs. The radio base stations 1a-b could also be in the form of Node Bs, BTSs (Base Transceiver Stations) and/or BSSs (Base Station Subsystems). Moreover, one or more of the radio base stations 1a-b could be a remote radio unit under control of a radio base station. In any case, each radio base station 1a-b provides radio connectivity to one or more mobile communication terminals 2. The term mobile communication terminal is also known as UE, mobile terminal, user terminal, user agent, etc. and can e.g. be embodied in a mobile telephone, a machine-to-machine device, a computer, a computer peripheral, etc.

The radio base stations 1a-b are also connected to the core network 6, via an S1 interface in an embodiment when the cellular communication system complies with LTE, for connectivity to central functions and other networks. For example, a Mobility Management Entity (MME) 3 is a network node being a control node for the access network, responsible for tasks such as idle mode tracking of the mobile communication in terminals 2, paging, retransmission, bearer activation/deactivation, etc. A serving gateway in routes and forwards user data packets, i.e. payload data and one or more PDN (Packet Data Network) gateway 11 is responsible for connectivity to external packet networks 7, such as the Internet, including potential filtering and billing support.

While the cellular communication network 5 of FIG. 1 shows two radio base stations 1a-b, the cellular communication network 5 can have any number of radio base stations and corresponding wireless radio interfaces and cells, supporting a suitable number of mobile communication terminals.

The communication between each mobile communication terminal 2 and the radio base stations 1a-b occurs over a wireless radio interface. Each radio base station 1a-b provides coverage using a corresponding cell. In this example, each radio base station 1a-b has a single associated cell. However, it is to be noted that each radio base station can have multiple associated cells and the number of associated cells can differ between radio base stations. In this example, the first radio base station ia is the serving radio base station for the illustrated mobile communication terminal 2.

If the mobile communication terminal 2 moves out of the coverage area of the first radio base station ia and into the coverage area of the second radio base station ib, a handover is performed by the cellular communication network 5. In such a handover, in this example, the first radio base station ia is the source node and the second radio base station ib is the target node.

FIG. 2 is a state diagram illustrating various modes of the mobile communication terminal 2 of FIG. 1. Each mobile communication terminal 2 has its own instance of modes and transitions, which are managed by a network node, such as a serving radio base station or MME. The modes relate to two inactivity timers managed by the network node for the mobile communication terminal in question: an inactivity timer for control signalling and an inactivity timer for payload data, also known as user data or user plane data.

There are four modes in this model: a fully active mode 15, an inactive payload mode 16, an inactive control mode 17 and an idle mode 20.

In the fully active mode 15, the mobile communication terminal is in a mode of normal communication and neither of the inactivity timer for control signalling nor the inactivity timer for payload data have expired.

In the inactive control mode 17, the mobile communication terminal is still in a mode of normal communication. Here, however, the inactivity timer for control signalling has expired, while the inactivity timer for payload data has not expired.

In the inactive payload mode 16, the mobile communication terminal is still in a mode of normal communication. Here, however, the inactivity timer for payload data has expired, while the inactivity timer for control signalling has not expired.

In the idle mode 20, the mobile communication terminal is in an idle mode. For example, the idle mode can be an RRC IDLE mode.

Having described the modes, the transitions between the modes will now be discussed.

From the fully active mode 15, if the inactivity timer for control signalling expires 21, there is a transition to the inactive control mode 17. Alternatively, from the fully active mode 15, if the inactivity timer for payload data expires 23, there is a transition to the inactive payload mode 16. If the network node detects 28 control signalling associated with the mobile communication terminal, the inactivity timer for control signalling is reset and the mobile communication terminal remains in the fully active mode 15.

Analogously, if the network node detects 29 payload data associated with the mobile communication terminal (i.e. either to or from the mobile communication terminal), the inactivity timer for payload data is reset and the mobile communication terminal also remains in the fully active mode 15.

From the inactive control mode 17, if the inactivity timer for payload data expires 23, there is a transition to the idle mode 20. On the other hand, if the network node detects 28 control signalling associated with the mobile communication terminal, the inactivity timer for control signalling is reset and there is a transition to the fully active mode 15. Analogously, if the network node detects 29 payload data associated with the mobile communication terminal (i.e. either to or from the mobile communication terminal), the inactivity timer for payload data is reset and the mobile communication terminal also remains in the inactive control mode 17.

From the inactive payload mode 16, if the inactivity timer for control signalling expires 21, there is a transition to the idle mode 20. On the other hand, if the network node detects 29 payload data associated with the mobile communication terminal, the inactivity timer for payload data is reset and there is a transition to the fully active mode 15. If the network node detects 28 control signalling associated with the mobile communication terminal, the inactivity timer for control signalling is reset and the mobile communication terminal remains in the inactive payload mode 15.

From the idle mode 20, if the network node detects 28 control signalling associated with the mobile communication terminal, the inactivity timer for control signalling is reset and there is a transition to the inactive payload mode 16. If the network node detects 29 payload data associated with the mobile communication terminal, the inactivity timer for payload data is reset and there is a transition to the inactive control mode 17.

The state diagram could be varied in many ways, but in any case, both inactivity timers expire to reach the idle mode 20. By using a model where both inactivity timers have to expire for the mobile communication terminal to go in to idle mode 20, the risk of setting the mobile communication terminal in idle mode when control signalling still occurs is greatly reduced. For example, this reduces paging load, risk of repeating SMS (Short Messaging Service) messages and failure during a positioning procedure, which may take a considerable amount of time.

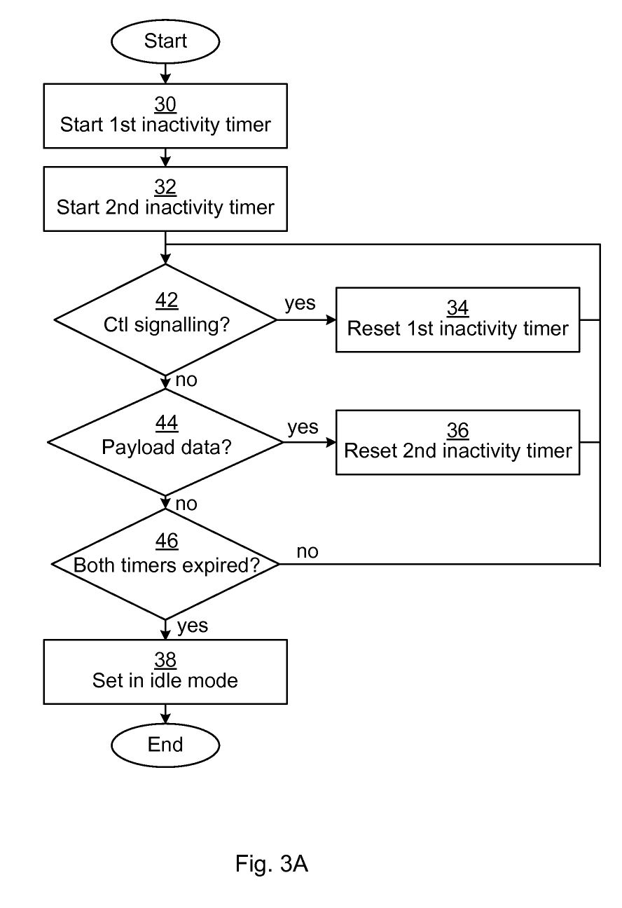

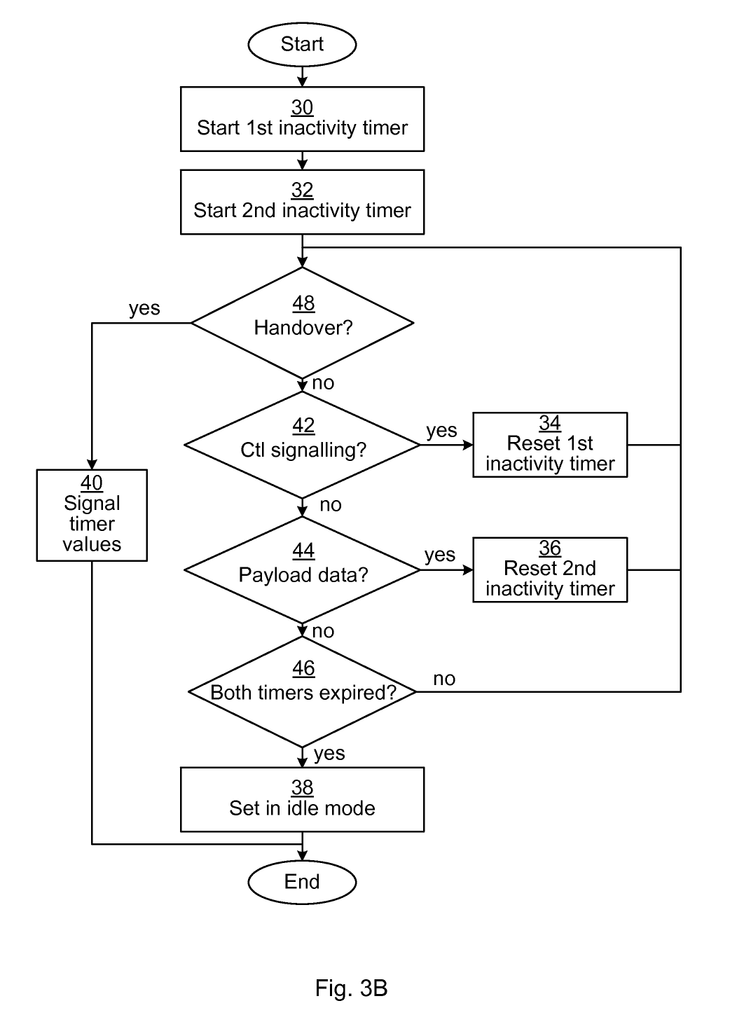

FIGS. 3A-B are flow charts illustrating methods executed in a network node of FIG. 1 for setting a mobile communication terminal of a cellular communication network in an idle mode. The methods correspond to the state diagram of FIG. 2. Firstly, the method illustrated by the flow chart of FIG. 3A will be described.

In a start 1^{st} inactivity timer step 30, a first inactivity timer is started. The first inactivity timer is the same as the control signalling timer described above with reference to FIG. 2. The first inactivity timer can be implemented in any suitable way which allows it to be determined when it has expired and also has an ability to be reset. For example, the first inactivity timer can be set to an initial value and the first inactivity timer can decrease over time and expire when it reaches zero. In another example the first inactivity timer is initially set to zero and it increases over time until it reaches an expiration value.

In a start 2^{nd} inactivity timer step 32, a second inactivity timer is started. The second inactivity timer is the same as the payload data timer described above with reference to FIG. 2. As for the first inactivity timer, the second inactivity timer can be implemented in any suitable way which allows it to be determined when it has expired and also has an ability to be reset. For example, the second inactivity timer can be set to an initial value and the second inactivity timer can decrease over time and expire when it reaches zero. In another example the second inactivity timer is initially set to zero and it increases over time until it reaches an expiration value.

In a conditional control signalling step 42, it is determined whether control signalling associated with the mobile communication terminal, is detected. This second node can be any node in the network, such as an MME, an S-GW, a P-GW, a radio base station, etc., as long as it is not the network node performing the method. If this is the case, the method continues to a reset 1st inactivity timer step 34. Otherwise, the method continues to a conditional payload data step 44.

Optionally, the control signalling is between the mobile communication terminal and a second node distinct from the network node. In this case, the content of the control signalling between the mobile communication terminal and the second node is typically not intended for the network node executing the method. For example, the control signalling can comprise non-access stratum signalling. Optionally, the conditional control signalling step 42 is only responsive to non-access stratum signalling. Non-access stratum signalling is signalling not directly related to the radio access network. In this way, when the network node is a radio base station, the network node resets the timer, even when it is not concerned with the content of the signalling; the network node can however see that there is signalling to or from the mobile communication terminal in question and resets the first inactivity timer in response to this, presumably, control signalling.

In another embodiment, the control signalling is intended for the network node, e.g. when the control signalling is used for the purpose of services utilizing the control plane as a bearer, such as for positioning based on LPPa (LTE Positioning Protocol A). In the example of LPPa, the LPPa signalling originates from a positioning node and is relayed by the MME to the radio base station. This can trigger the radio base station to either perform an internal execution (e.g. retrieving a measurement) or to start a signalling procedure towards the mobile communication terminal. In the latter case it means that the control signalling from the mobile communication terminal is intended for the radio base station, although the radio base station in its turn will use the signalling to trigger response signalling towards the MME (and further on to the positioning node). This control signalling between the mobile communication terminal and the radio base station cases a reset of the first inactivity timer.

In the reset 1^{st} inactivity timer step 34, the first inactivity timer is reset. After this step, the method returns to the conditional control signalling step 42.

In the conditional payload data step 44, it is determined whether payload data associated with the mobile communication terminal is detected. If this is the case, the method continues to a reset 2^{nd} inactivity timer step 36. Otherwise, the method continues to a conditional both timers expired step 46.

In the reset 2^{nd} inactivity timer step 36, the second inactivity timer is reset. After this step, the method returns to the conditional control signalling step 42.

In the conditional both timers expired step 46, it is determined whether both the first inactivity timer and the second inactivity timer have expired. If this is the case, the method continues to a set in idle mode step 38. Otherwise, the method returns to the conditional control signalling step 42. In other words, as a response to both inactivity timers having expired, the method continues to the set in idle mode step 38.

The expiration times for the first inactivity timer and the second inactivity timer can be the same or they can differ. This gives full flexibility in terms of how long inactivity is accepted for control signalling and payload data, respectively.

In the set in idle mode step 38, the mobile communication terminal is set in an idle mode, e.g. an RRC IDLE mode. This can e.g. be performed by an UE Context Release procedure, in the example of LTE. The UE Context Release procedure is triggered either by the radio base station or the MME.

When the procedure is triggered by the MME, a UE CONTEXT RELEASE COMMAND message is sent over S1 to the radio base station. The radio base station sends an RRC CONNECTION RELEASE message using RRC (Radio Resource Control) to the mobile communication terminal and then clears all resources related to the mobile communication terminal. The radio base station ends the procedure by sending the UE CONTEXT RELEASE COMPLETE message back to the MME.

When the procedure in triggered by the radio base station, a UE CONTEXT RELEASE REQUEST message is sent over S1 to the MME. The rest of the procedure is identical to an MME triggered release.

It is to be noted that the order of the conditional control signalling step 42 and the conditional payload data step 44 is not important. Also, the order of the start 1st inactivity timer step 30 and start 2^{nd} inactivity timer step 32 is not important.

The method illustrated by the flow chart of FIG. 3B will now be described. The steps of FIG. 3A have equivalent steps in FIG. 3B and will not be explained again unless they differ in any way.

In this method, there is a conditional handover step 48 after the start second inactivity timer step 32. In the conditional handover step 48, it is determined whether it has been decided to hand over the mobile communication terminal from a source node to a target node. If this is the case, the method continues to a signal timer values step 40. Otherwise, the method continues to the conditional control signalling step 42.

In the signal timer values step 40, the values of the first inactivity timer and the second inactivity timer are signalled to the target node. This allows the present state of the inactivity timers to follow the mobile communication terminal when handover occurs. After the signal timer values step 40.

It is to be noted that the conditional handover step 48 can be positioned anywhere in the flow chart between the start second inactivity timer and the conditional both timers expired step 46.

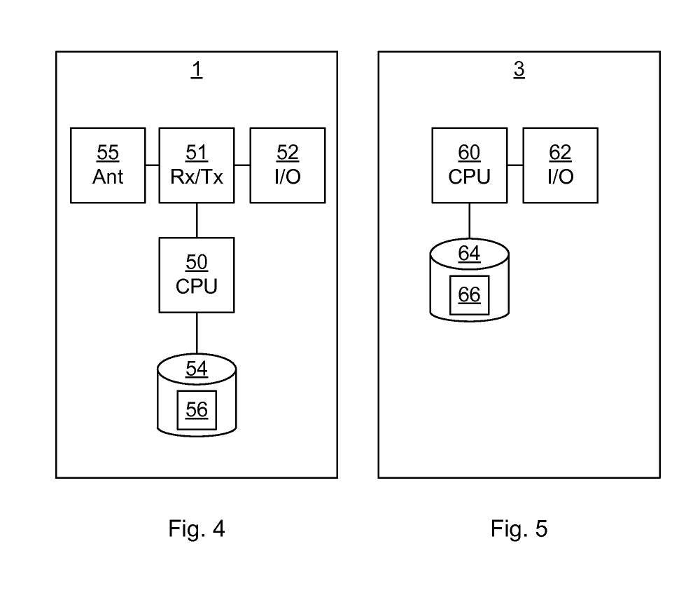

FIG. 4 is a schematic diagram illustrating elements of any one of the radio base stations of FIG. 1, here represented by a single radio base station 1. A processor 50 is provided using any combination of one or more of a suitable central processing unit (CPU), multiprocessor, microcontroller, digital signal processor (DSP), application specific integrated circuit etc., capable of executing software instructions 56 stored in a computer program product 54, e.g. in the form of a memory. The processor 50 can be configured to execute the method described with reference to FIGS. 3A-B above.

The computer program product 54 can be a memory being any combination of read and write memory (RAM) and read only memory (ROM). The memory also comprises persistent storage, which, for example, can be any single one or combination of solid state memory, magnetic memory, or optical memory.

The radio base station 1 further comprises an I/O interface 52 e.g. for communicating the core network (e.g. over S1) and/or other radio base stations (e.g. over X2), for instance during handover.

The radio base station 1 also comprises one or more transceivers 51, comprising analogue and digital components, and a suitable number of antennas 55 for radio communication with mobile communication terminals. The processor 50 controls the general operation of the radio base station 1, e.g. by sending control signals to the transceiver S1 and receiving reports from the transceiver 51 of its operation.

Other components of the radio base station 1 are omitted in order not to obscure the concepts presented herein.

FIG. 5 is a schematic diagram illustrating elements of the MME 3 of FIG. 1. A processor 60 is provided using any combination of one or more of a suitable central processing unit (CPU), multiprocessor, microcontroller, digital signal processor (DSP), application specific integrated circuit etc., capable of executing software instructions 66 stored in a computer program product 64, e.g. in the form of a memory. The processor 60 can be configured to execute the method described with reference to FIGS. 3A-B above.

The computer program product 64 can be a memory being any combination of read and write memory (RAM) and read only memory (ROM). The memory also comprises persistent storage, which, for example, can be any single one or combination of solid state memory, magnetic memory, or optical memory.

The MME 3 further comprises an I/O interface 62 e.g. for communicating other components of the core network and/or radio base stations (e.g. over S1).

Other components of the MME 3 are omitted in order not to obscure the concepts presented herein.

The invention has mainly been described above with reference to a few embodiments. However, as is readily appreciated by a person skilled in the art, other embodiments than the ones disclosed above are equally possible within the scope of the invention, as defined by the appended patent claims.

1. A method for setting a mobile communication terminal of a cellular communication network in an idle mode, the method being performed in a network node and comprising the steps of:
starting a first inactivity timer;
starting a second inactivity timer;
resetting the first inactivity timer when control signalling associated with the mobile communication terminal is detected;
resetting the second inactivity timer when payload data associated with the mobile communication terminal is detected; and
setting the mobile communication terminal in an idle mode when both the first inactivity timer and the second inactivity timer have expired.

2. The method according to claim 1, wherein the step of resetting the first inactivity timer comprises resetting the first inactivity timer when control signalling between the mobile communication terminal and a second node distinct from the network node is detected.

3. The method according to claim 1, wherein in the step of setting the mobile communication terminal in an idle mode, the expiration times for the first inactivity timer and the second inactivity timer differ.

4. The method according to claim 1, wherein the content of the control signalling between the mobile communication terminal and the second node is not intended for the network node.

5. The method according to claim 1, wherein the step of setting the mobile communication terminal in an idle mode comprises setting the mobile communication terminal in an RRC_IDLE mode.

6. The method according to claim 1, wherein the control signalling comprises non-access stratum signalling.

7. The method according to claim 1, further comprising the step of:
signalling values of the first inactivity timer and the second activity timer to a target node when handover to the target node occurs.

8. A network node arranged to set a mobile communication terminal of a cellular communication network in an idle mode, the network node comprising:
a processor; and
a computer program product storing instructions that, when executed by the processor, causes the network node to:
start a first inactivity timer;
start a second inactivity timer;
reset the first inactivity timer when control signalling associated with the mobile communication terminal is detected;
reset the second inactivity timer when payload data associated with the mobile communication terminal is detected; and
set the mobile communication terminal in an idle mode when both the first inactivity timer and the second inactivity timer have expired.

9. The network node according to claim 8, wherein the instructions to reset the first inactivity timer comprise instructions to reset the first inactivity timer when control signalling between the mobile communication terminal and a second node distinct from the network node is detected.

10. The network node according to claim 8, wherein the expiration times for the first inactivity timer and the second inactivity timer differ.

11. The network node according to claim 8, wherein the instructions to set the mobile communication terminal in an idle mode comprise instructions to transmit a context release message.

12. The network node according to claim 8, wherein the content of the control signalling between the mobile communication terminal and the second node is not intended for the network node.

13. The network node according to claim 8, wherein the control signalling comprises non-access stratum signalling.

14. The network node according to claim 8, wherein the instructions further comprise instructions to:
signal timer values of the first inactivity timer and the second activity timer to a target node when handover to the target node occurs.

15. The network node according to claim 8, wherein the network node is a radio base station.

16. The network node according to claim 8, wherein the network node is a mobility management entity node.
